(19) United States
(12) Patent Application Publication
(10) Pub. No.: US 2003/0126149 A1
(43) Pub. Date: Jul. 3, 2003

(54) System for providing private branch exchange operation information

(76) Inventors: Sung-Sik Jung, Suwon-shi (KR); Woong-Hee Ryu, Seoul (KR)

Correspondence Address: Robert E. Bushnell, Suite 300, 1522 K Street, N. W., Washington, DC, 20005, US

(21) Appl. No.: 10/314,403

(22) Filed: Dec. 9, 2002

(30) Foreign Application Priority Data
Dec. 31, 2001 (KR) 2001-89102

(51) Int. Cl. G06F 7/00

(52) U.S. Cl. 707/100

(57) ABSTRACT

A system for providing private branch exchange (PBX) operation information outputted through a computer-telephony integration (CTI) interface as CTI events, the system comprising: an operation information web server storing various PBX operation information received through the CTI interface; and at least one client PC (personal computer) connected via the Internet to the operation information web server, the client PC making a request to the operation information web server for the PBX operation information, and the operation information web server responsively converting the PBX operation information to an HTML (Hyper Text Markup Language) file and transmitting the HTML file to the client PC such that the client PC displays the received information on a monitor. The system provides various operation information generated in a PBX to a user, without installation of a separate program.

### CLAIM OF PRIORITY

This application makes reference to, incorporates the same herein, and claims all benefits accruing under 35 U.S.C §119 from an application Entitled System For Providing Private Branch Operation Information earlier filed in the Korean Industrial Property Office on Dec. 31, 2001, and there duly assigned Ser. No. 2001-89102 by that Office.

### BACKGROUND OF THE INVENTION

1. Field of the Invention

The present invention relates to a private branch exchange (PBX), and more particularly to a system for providing various kinds of information generated by the operation of the private branch exchange to a user.

2. Description of the Related Art

Generally, in order that a user such as a manager, an operator, etc., identifies various kinds of information generated by the operation of a private branch exchange, the user has received the related information from the private branch exchange through a personal computer using a program particularly dedicated to this. As the information, there may be included, for example, statistical information related to various call statuses, monitoring information for the progress of a current call, diagnosis-related information, etc. When an alarm or a fault in the private branch exchange occurs and the alarm or fault is retrieved, the alarm or fault information is stored in a hard disk of the private branch exchange so that the manager can find the stored information and analyze the cause of the alarm or fault. However, in order to diagnose the alarm or fault, the manager must access the stored information of the private branch exchange, analyze the cause and take an action on the cause. Accordingly, the procedure requires much time and specialized knowledge.

In addition, the manager must distribute a particular program to view the operation information such as statistical information, monitoring information and diagnosis-related information to the user, and each user must install the program in his personal computer. As such, when the user is in some places where the program is not installed, he cannot view the corresponding operation information. Furthermore, the program has a structure that allows only one user to connect to one private branch exchange. The disadvantage of such program is that many users cannot connect to the private branch exchange and thus cannot simultaneously use the statistical information or monitoring information provided from the private branch exchange.

The extraction of periodic statistical information for various call statuses provided from the private branch exchange has been commonly performed by storing the information a separate computer file or outputting the information from a printer through a program connected to the private branch exchange. However, there still exists a problem that many users cannot simultaneously access the corresponding information. Also, statuses of the required statistical information vary depending on the users, but the conventional private branch exchanges have not each provided the required statistical information to the users.

### SUMMARY OF THE INVENTION

Therefore, the present invention has been made in view of the above problems, and it is an object of the present invention to provide a system for providing private branch exchange operation information that can easily provide the operation information generated in a private branch exchange to a user without installation of a separate program.

It is another object of the present invention to provide a system for providing private branch exchange operation information that can easily provide the required periodic statistical information to a user.

To achieve the above objects, there is provided a system for providing PBX operation information outputted through a CTI (Computer-Telephony Integration) interface as CTI events, the system comprising: an operation information web server storing various PBX operation information received through the CTI interface; and at least one client PC (Personal Computer) connected to the operation information web server using a web (that is, the World Wide Web (WWW) or Internet), the client PC making a request for the PBX operation information to the operation information web server, and the operation information web server responsively transmitting an HTML (Hyper Text Markup Language) file containing the requested information to the client PC such that the client PC displays the received information on a monitor.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a diagram showing a configuration of a system for providing PBX operation information according to one embodiment of the present invention;

FIG. 2 is a block diagram showing software of an operation information web server according to another embodiment of the present invention;

FIG. 3 is a flow diagram illustrating a procedure for providing monitoring information of an operation information web server according to another embodiment of the present invention;

FIG. 4 is a flow chart illustrating a procedure for providing statistical information of an operation information web server according to another embodiment of the present invention;

FIG. 5 is a flow chart illustrating a procedure for providing periodic statistical information of an operation information web server according to another embodiment of the present invention; and

FIG. 6 is a flow chart illustrating a procedure for providing diagnostic information of an operation information web server according to another embodiment of the present invention.

### DETAILED DESCRIPTION OF THE PREFERRED EMBODIMENTS

Hereinafter, the preferred embodiments of the system according to the present invention will be explained in more detail with reference to the accompanying drawings. In the following description and accompanying drawings, well-known functions or constructions are not described in detail since they would obscure the invention in unnecessary detail.

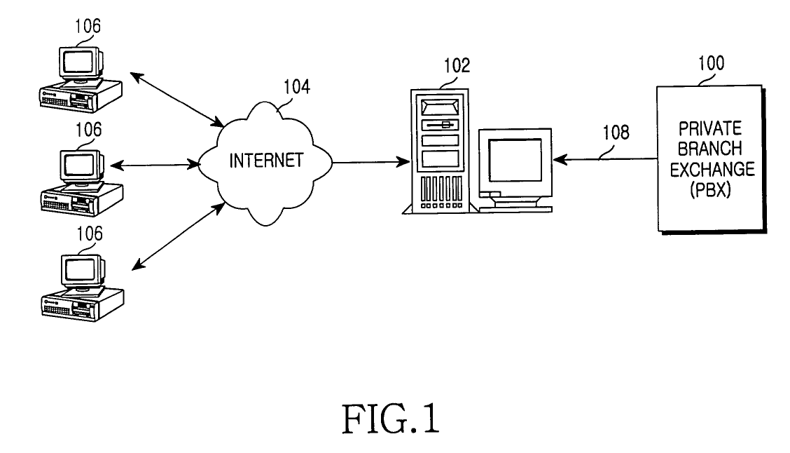

FIG. 1 is a diagram showing a configuration of a system for providing PBX operation information according to one embodiment of the present invention. Referring to FIG. 1, an operation information web server 102 is connected to a private branch exchange 100 through a CTI interface 108, and at least one client PC 106 is connected to the operation information web server 102 using a web via an Internet 104. The client PC 106 may be connected to the operation information web server 102 via an intranet instead of the Internet 104.

The operation information web server 102 stores various PBX operation information received through the CTI interface as CTI events. The operation information outputted from the PBX 100 as CTI events includes statistical information related to various call statuses, monitoring information for the progress of a current call, information for the system statuses, information related to alarms and faults, etc., as described above.

The client PC 106 is connected to the operation information web server 102 using a web by a user. At this time, the user sends a request for the operation information to the operation information web server 102. When there is a request for the operation information from the client PC 106, the operation information web server 102 transmits an HTML file containing the requested information to the client PC 106. Then, the client PC 106 receives the requested information from the operation information web server 102 as the HTML file and displays the received information on a monitor. Therefore, the user can view various operation information from the PBX 100 through a web browser at any place as long as the Internet can be accessed.

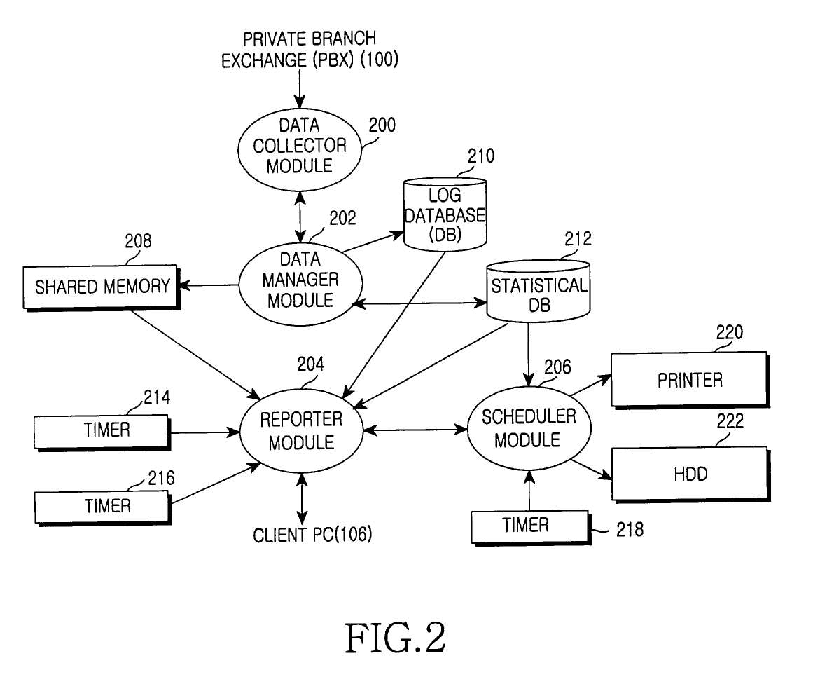

FIG. 2 is a block diagram showing software of the operation information web server 102 according to another embodiment of the present invention. Referring to FIG. 2, the operation information web server 102 includes a data collector module 200, a data manager module 202, and a reporter module 204.

The data collector module 200 is a module which is responsible for direct interface with the PBX 100 through the CTI interface 108. The data collector module 200 extracts the PBX monitoring information, statistical information, periodic statistical information, diagnostic information, information for system statuses and information related to alarms and faults for the private branch exchange from CTI events received from the PBX 100 through the CTI interface 108, and stores the extracted information in a shared memory 208 or provides it to the data manager module 202. The data manager module 202 analyzes, classifies and processes the extracted information by the data collector module 200, and then stores the processed information in the shared memory 208 or a log database (DB) 210 or a statistical database 212.

The reporter module 204, which provides an interface as an HTML file to a user of the client PC 106, is responsible for a user interface which collects the information, corresponding to a request by the client PC 106, from the shared memory 208, log database 210, statistical database 212, a hard disk drive (HDD) 222, and transmits an HTML file containing the requested information to the user.

The operation information web server 102 may further include a scheduler module 206 for processing the periodic statistical information according to processing conditions set by the user through the reporter module 204, and for outputting the resulting information to a printer 220 or storing the information in an HDD 222 as an HTML file and transmitting the HTML file to the user.

A plurality of timers 214 to 218 are used to inform the reporter module 204 or the scheduler module 206 whenever a time interval set by the user of the client PC 106 through the reporter module 204 is reached.

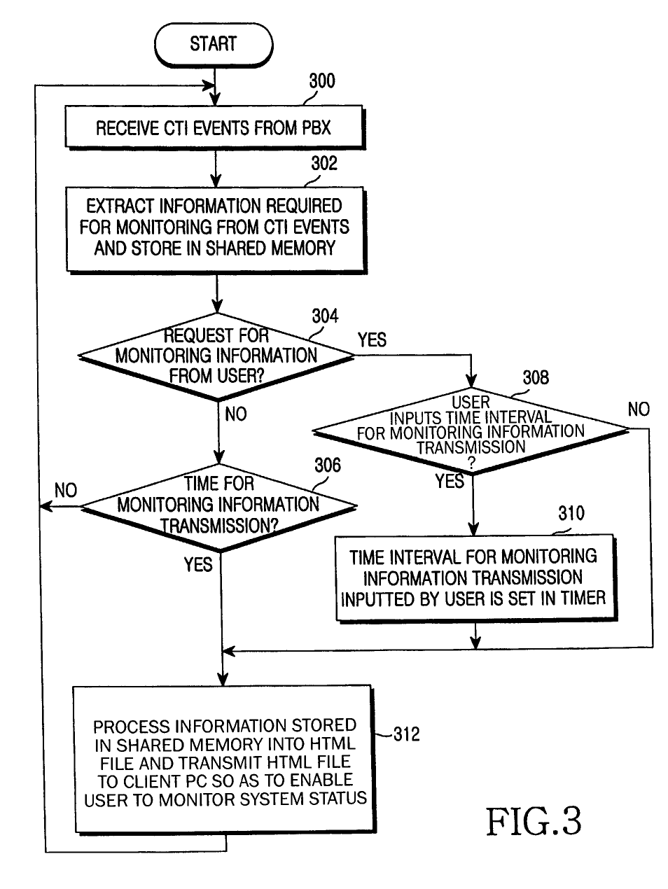

FIGS. 3 to 6 are flow diagrams illustrating procedures for providing PBX monitoring information, statistical information, periodic statistical information and diagnostic information via the operation information web server 102, respectively.

FIG. 3 is a flow diagram illustrating a procedure for providing PBX monitoring information via the operation information web server 102 according to another embodiment of the present invention. This figure illustrates an example to provide monitoring information as operation information to the user of the client PC 106. For this purpose, the data collector module 200 receives CTI events from the PBX 100 in step 300. The information required for monitoring is extracted from among the CTI events and stored in the shared memory 208 in step 302.

In steps 304 to 308, the reporter module 204 inspects whether or not monitoring information is requested by the user of the client PC 106, whether or not a time interval for monitoring information transmission is set, whether or not a time for monitoring information transmission by the timer 214 is reached.

When there is a request for the monitoring information from the user of the client PC 106 in step 304, the reporter module 204 inspects whether or not a time interval for the monitoring information transmission is input in step 308. Here, if the user inputs the time interval for monitoring information transmission, then step 310 is executed, and if otherwise, step 312 is executed.

In step 310, the time interval for the monitoring information transmission inputted by the user is set in the timer 214 by the reporter module 204, and subsequently step 312 is executed. Accordingly, the timer 214 informs the time for the monitoring information transmission to the reporter module 204 whenever the time interval set by the user is reached.

When there is no request for the monitoring information from the user of the client PC 106 in step 304, the reporter module 204 identifies the time for the monitoring information transmission in step 306. If the time for the monitoring information transmission is reached, step 312 is executed. If not, the procedure returns to the step 300.

In step 312, the reporter module 204 processes the information required for monitoring stored in the shared memory 208 into an HTML file, and transmits the processed information to the client PC 106 so as to enable the user to monitor the system statuses. Thereafter, the procedure returns to the step 300.

Accordingly, when the user connects to the operation information web server 102 through the client PC 106 using a web and requests the PBX monitoring information transmission, the PBX monitoring information which can monitor the PBX system statuses is transmitted as an HTML file, and thus the user can view the HTML file on a monitor. When the time interval for the monitoring information transmission is previously set up, the user can automatically view the PBX monitoring information as an HTML file according to a predetermined time interval.

The monitoring information is largely classified into the following information: system monitoring information and automatic call distribution (ACD) status monitoring information. Specifically, the system monitoring is classified into office line monitoring, extension monitoring, signal apparatus monitoring, internode interface (INI) monitoring, diagnostic monitoring, load factor monitoring, etc. Again, the office line monitoring and extension monitoring is further classified by their nodes and groups. The automatic call distribution (ACD) status is classified into an integrated status such as incoming call, outgoing call or interactive voice response (IVR) incoming call; and into a group-based status such as a group-based call process status, a group-based counselor status, etc.

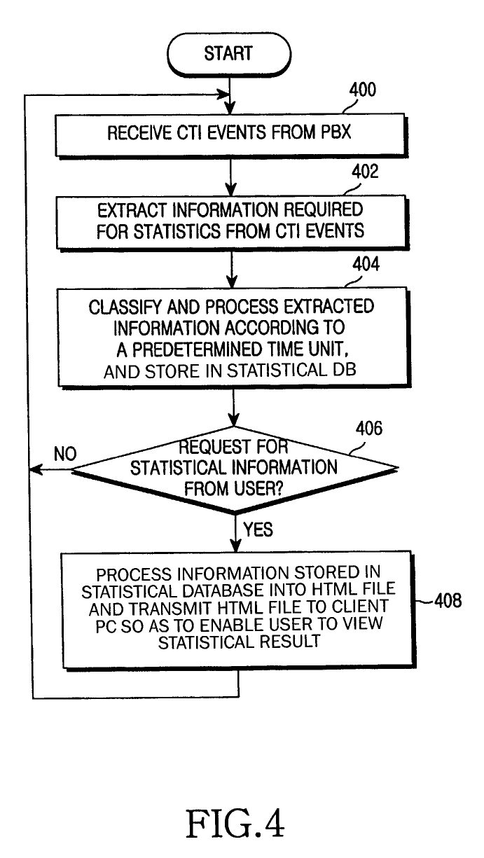

FIG. 4 is a flow chart illustrating a procedure for providing PBX statistical information via the operation information web server 102 according to another embodiment of the present invention. This figure illustrates an example to provide statistical information as operation information to the user of the client PC 106. For this purpose, the data collector module 200 receives CTI events from the PBX 100 in step 400. The information required for statistics is extracted from these CTI events. The data manager module 202 classifies the extracted information from the data collector module 200 and processes it according to a predetermined time unit, and then stores the processed information in the statistical database 212.

In step 406, the reporter module 204 inspects whether or not the user requests statistical information through the client PC 106. When there is a request for the statistical information from the user, the reporter module 204 processes, as an HTML file, the information stored in the statistical database 212, and transmits the HTML file to the client PC 106, in step 408, so that the user can view the statistical results. When there is no request for the statistical information from the user in step 406, or after the step 408 is executed, the procedure returns to the step 400.

Accordingly, when the user connects to the operation information web server 102 through the client PC 106 using a web and requests the PBX statistical information transmission, the user receives the PBX statistical information and thus can view it as an HTML file on a monitor.

Examples of the statistical information include system statistical information and automatic call distribution (ACD) statistical information. The system statistics are classified into office line node-based statistics, extension node-based statistics, port-based statistics, signal apparatus statistics, internode interface statistics, diagnostic statistics, load factor statistics, etc. The office line node-based statistics and extension node-based statistics are further classified into total, calling call, answering call, call distribution statistics, etc. The port-based statistics are further classified into office line, extension, etc. The automatic call distribution statistics are classified into automatic call distribution total statistics, automatic call distribution device statistics, group-based statistics and distribution (analysis), counselor-based statistics and distribution (analysis), etc. Specifically, the group-based statistics and distribution are classified into call statistics, and waiting call/abandoned call/responding call distribution statistics. The counselor-based statistics and distribution are classified into group-based result, individual result and part-based statistics.

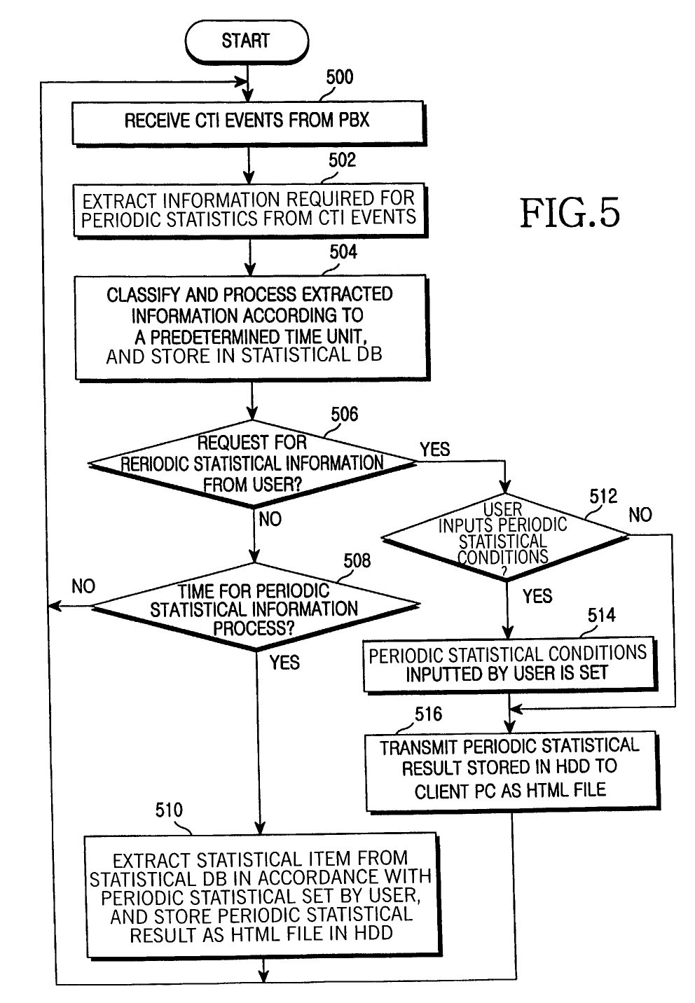

FIG. 5 is a flow chart illustrating a procedure for providing PBX periodic statistical information via the operation information web server 102 according to another embodiment of the present invention. This figure illustrates an example to provide the periodic statistical information as operation information to the user of the client PC 106.

In steps 500 to 516, the PBX periodic statistical information, such as various call progress statuses, generated in the PBX 100 is extracted by the conditions previously inputted by the user according to a predetermined time unit and stored so that the stored information can be viewed on a monitor or outputted from a printer when the user want to view the stored information. For this purpose, the data collector module 200 receives CTI events from the PBX 100 in step 500.

The information required for PBX periodic statistical information is extracted from among the CTI events in step 502. In step 504, the data manager module 202 classifies and processes the extracted information received by the data collector module 200 according to a predetermined time unit, and then stores the processed information in the statistical database 212.

In step 506, the reporter module 204 inspects whether or not the periodic statistical information is requested by the user of the client PC 106. In step 508 the scheduler module 206 determines, via scheduler module 206, whether or not a time interval for a periodic statistical information process previously inputted by the user is reached by timer 218 when it is determined by the reporter module 204 that the user has not requested the PBX periodic statistical information.

When there is a request for the periodic statistical information from the user of the client PC 106 in step 506, the reporter module 204 inspects whether or not the user inputs periodic statistical conditions in step 512. Examples of the periodic statistical conditions include items to be extracted as periodic statistics from among the statistical information items, extraction time, output periods, storing location of the output, printer output time and backup location. The statistical period may be set in a period of a day, a week, a month, etc. If the user inputs the periodic statistical conditions, the scheduler module 206 executes step 514. Otherwise, step 516 is executed.

In step 514, the scheduler module 206 sets the periodic statistical conditions inputted by the user. The time for the statistical information process is set in the timer 218. The timer 218 informs the scheduler module 206 of the time for the periodic statistical information process. After step 514, step 516 (discussed below) is executed.

When there is no request for the periodic statistical information from the user of the client PC 106 in step 506, the reporter module 204 identifies whether or not the time for the periodic statistical information process is reached by the timer 218 in step 508. When the time for the periodic statistical information process has been reached, step 510 is executed. Otherwise, step 500 is executed.

In step 510, the scheduler module 206 extracts statistical items from the statistical database 212 in accordance with the setup of the periodic statistical conditions, and stores the statistical results as one or more HTML files in the HDD 222. The results may be outputted from the printer 220. Thereafter, the procedure returns to the step 500.

In step 516, the reporter module 204 transmits the HTML files of the periodic statistical results stored in the HDD 222 to the client PC 106. Of course, the reporter module 204 cannot transmit HTML files until the periodic statistical results are stored in the HDD 222 via steps 500-510.

Accordingly, when user connects to the operation information web server 102 through the client PC 106 using a web and requests the PBX periodic statistical information transmission, the PBX periodic statistical information processed by the scheduler module 206 is transmitted as an HTML file, and thus the user can view the HTML file on a monitor.

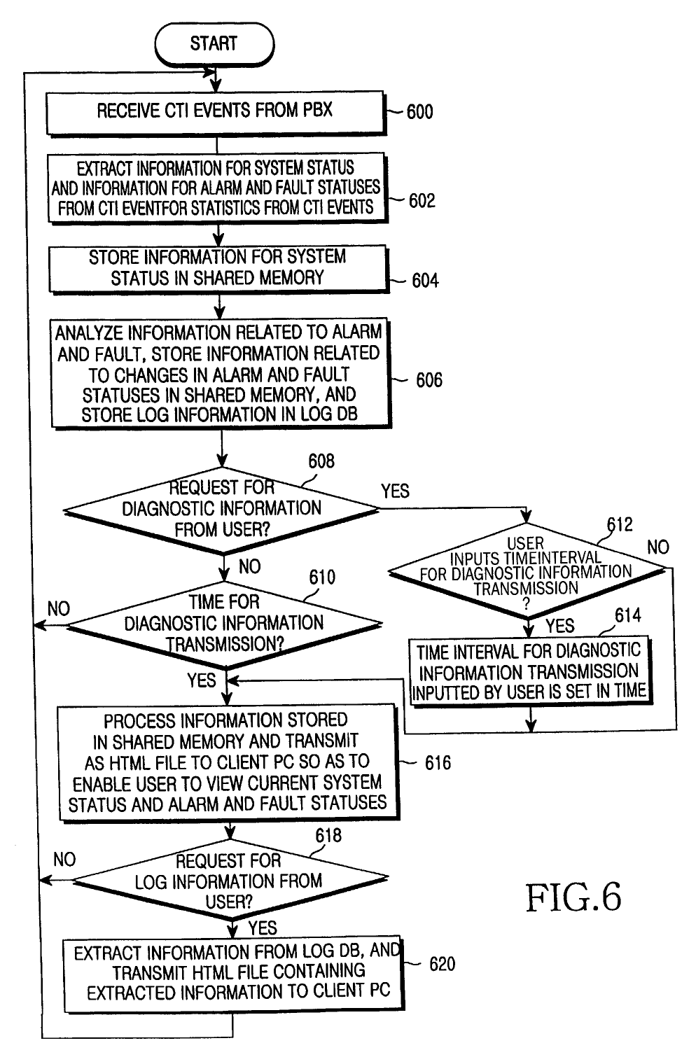

FIG. 6 is a flow chart illustrating a procedure for providing PBX diagnostic information via the operation information web server 102 according to another embodiment of the present invention. This figure illustrates an example to provide diagnostic information as operation information to the user of the client PC 106.

The data collector module 200 receives CTI events from the PBX 100 in step 600. The information for system statuses is extracted from among the received CTI events in step 602, and the extracted information is stored in the shared memory 208 in step 604. The alarm and fault related information (not shown) is also extracted and transferred to the data manager module 202 in step 604.

In step 606, the data manager module 202 analyses the information extracted by the data collector module 200, stores the information related to changes in alarm and fault statuses in the shared memory 208, and stores log information according to the information related to changes in alarm and fault statuses in the log database 210.

In steps 608 to 620, the reporter module 204 inspects whether or not the diagnostic information is requested by the user of the client PC 106, whether or not a time interval for diagnostic information transmission is set, whether or not a time for diagnostic information transmission by the timer 216 is reached.

When there is a request for diagnostic information from the user of the client PC 106 in step 608, the reporter module 204 inspects whether or not a time interval for the diagnostic information transmission is set in step 612. When the user sets the time interval for the diagnostic information transmission, step 614 is executed. Otherwise, step 616 is executed.

In step 614, the reporter module 204 sets the time interval for the diagnostic information transmission inputted by the user in the timer 216, and then step 616 is executed. The timer 216 informs the time for the diagnostic information transmission in accordance with the time interval set by the user to the scheduler module 206.

When there is no request for the diagnostic information from the user of the client PC 106 in step 608, the reporter module 204 identifies in step 610 whether or not the time for the diagnostic information transmission by the timer 216 is reached. When the time for the diagnostic information transmission is reached, step 616 is executed. Otherwise, step 600 is executed.

In step 616, the reporter module 204 processes the information stored in the shared memory 208 and transmits it as an HTML file to the client PC 106 so as to enable the user to view the current system status and alarm and fault statuses.

In step 618, whether or not a request for the log information from the user is inspected. When there is a request for the log information, the reporter module 204 extracts the corresponding information from the log database 210, and transmits it as an HTML file containing the extracted information to the client PC 106 in step 620. When there is no request for the log information, the procedure returns to step 600.

Accordingly, when the user connects to the operation information web server 102 through the client PC 106 using a web and requests the PBX diagnostic information transmission, the PBX diagnostic information is transmitted as an HTML file and thus the user can view the HTML file on a monitor.

Since the present invention provides a web-based user interface familiar to the user, the user can manage various operation information, e.g., statistical information, monitoring information, diagnostic information, etc., from the PBX through a web browser anywhere as long as the Internet can be accessed, without installation of a separate program. The system for providing PBX operation information according to the present invention is a structure in which all information provided to a server is stored and managed. Therefore, batch management of the information, changes and additions of function are possible, and general database, etc., can be easily linked with the system. Further, periodic statistical information can be easily provided to a user.

Those skilled in the art will appreciate that various modifications to the details of the present invention may easily be made without departing from the scope of the present invention. Specifically, monitoring information, statistical information, periodic statistical information and diagnostic information are mentioned, as the information provided in the present invention. However, if desired, one piece of the information can be selected, and other information can be provided in accordance with the operation of PBX. In addition, the timer used to report to the user can be omitted. Therefore, the scope of the invention is indicated by the appended claims and the equivalency of the claims, rather than the embodiments as described above.

What is claimed is:

1. A system providing private branch exchange operation information, outputted from a private branch exchange through a computer-telephony integration interface as computer-telephony integration events, to a client personal computer, the system comprising:
an operation information web server storing the private branch exchange operation information received through the computer-telephony integration interface;
at least one said client personal computer connected to the operation information web server using an Internet, the client personal computer making a request to the operation information web server for the private branch exchange operation information;
said operation information web server responsively processing the private branch exchange operation information into an HTML (Hyper Text Markup Language) file containing the requested private branch exchange operation information and transmitting the HTML file to the client personal computer; and
said client personal computer displaying on a monitor the received HTML file containing the private branch exchange operation information.

2. The system as set forth in claim 1, said operation information web server including:
a data collector module extracting said private branch exchange operation information from the computer-telephony integration events received from the private branch exchange;
a shared memory storing said private branch exchange operation information extracted by said data collector module; and
a reporter module processing the stored private branch exchange operation information stored in the shared memory into the HTML file containing the requested private branch exchange operation information, when a user of the client personal computer requests said private branch exchange operation information, and transmitting the HTML file containing the processed information to the client personal computer.

3. The system as set forth in claim 1, said private branch exchange operation information comprising private branch exchange monitoring information, private branch exchange statistical information, private branch exchange periodic statistical information and private branch exchange diagnostic information.

4. The system as set forth in claim 3, said operation information web server including:
a data collector module extracting said private branch exchange operation information from the computer-telephony integration events received from the private branch exchange;
a data manager module analyzing, classifying and processing said private branch exchange operation information extracted by said data collector module;
a shared memory storing extracted information output from said data collector module and processed information output from said data manager module; and
a reporter module processing the extracted information or the processed information stored in the shared memory into the HTML file containing the requested private branch exchange operation information, when a user of the client personal computer requests said private branch exchange operation information, and transmitting the HTML file containing the processed information to the client personal computer.

5. The system as set forth in claim 4, said operation information web server further including:
a monitoring information timer, said monitoring information timer being set by said reporter module when said user sets a time interval for transmission of said private branch exchange monitoring information;
said reporter module determining whether said user requests transmission of said private branch exchange monitoring information;
said reporter module checking said monitoring information timer to determining whether said time interval for transmission of said private branch exchange monitoring information is reached when said user does not request transmission of said private branch exchange monitoring information;
said reporter module checking whether said time interval for transmission of said private branch exchange monitoring information is input by said user when said user requests transmission of said private branch exchange monitoring information;
said reporter module setting said time interval for transmission of said private branch exchange monitoring information into said monitoring information timer when it is determined that said time interval for transmission of said private branch exchange monitoring information is input; and
said reporter module processing the private branch exchange monitoring information stored in the shared memory into an HTML file containing the requested private branch exchange monitoring information, after said time interval for transmission of said private branch exchange monitoring information is reached, when it is determined that said time interval for transmission of said private branch exchange monitoring information is not input or after said monitoring information timer is set with said time interval for transmission of said private branch exchange monitoring information upon determination that said time interval for transmission of said private branch exchange monitoring information is input, and transmitting the HTML file containing the private branch exchange monitoring information to the client personal computer.

6. The system as set forth in claim 4, said operation information web server further including:
a diagnostic information timer, said diagnostic information timer being set by said reporter module when said user sets a time interval for transmission of said private branch exchange diagnostic information;
said reporter module determining whether said user requests transmission of said private branch exchange diagnostic information;
said reporter module checking said diagnostic information timer to determining whether said time interval for transmission of said private branch exchange diagnostic information is reached when said user does not request transmission of said private branch exchange diagnostic information;
said reporter module checking whether said time interval for transmission of said private branch exchange diagnostic information is input by said user when said user requests transmission of said private branch exchange diagnostic information;
said reporter module setting said time interval for transmission of said private branch exchange diagnostic information into said diagnostic information timer when it is determined that said time interval for transmission of said private branch exchange diagnostic information is input; and
said reporter module processing the private branch exchange diagnostic information stored in the shared memory into an HTML file containing the requested private branch exchange diagnostic information, after said time interval for transmission of said private branch exchange diagnostic information is reached, when it is determined that said time interval for transmission of said private branch exchange diagnostic information is not input or after said diagnostic information timer is set with said time interval for transmission of said private branch exchange diagnostic information upon determination that said time interval for transmission of said private branch exchange diagnostic information is input, and transmitting the HTML file containing the private branch exchange diagnostic information to the client personal computer.

7. The system as set forth in claim 6, said private branch exchange diagnostic information including information for system statuses and information for alarm and fault statuses.

8. The system as set forth in claim 7, said operation information web server further including:
said shared memory storing said information for system statuses;
a log database storing log information according to information related to changes in said alarm and fault statuses;
said data manager module analyzing, classifying and processing said private branch exchange diagnostic information and storing the information related to changes in said alarm and fault statuses in said shared memory and storing said log information according to said information related to changes in said alarm and fault statuses into said log database;
said reporter module processing the information related to changes in said alarm and fault statuses stored in the shared memory into an HTML file containing the requested information related to changes in said alarm and fault statuses, after said time interval for transmission of said private branch exchange diagnostic information is reached, when it is determined that said time interval for transmission of said private branch exchange diagnostic information is not input or after said diagnostic information timer is set with said time interval for transmission of said private branch exchange diagnostic information upon determination that said time interval for transmission of said private branch exchange diagnostic information is input, and transmitting the HTML file containing the information related to changes in said alarm and fault statuses to the client personal computer;
said reporter module determining whether said user requests log information after transmitting the HTML file containing the information related to changes in said alarm and fault statuses to the client personal computer; and
said reporter module extracting the log information from said log database, when it is determined said user requests the log information, and processing the log information into an HTML file containing the requested log information and transmitting the HTML file containing the log information to the client personal computer.

9. The system as set forth in claim 4, said operation information web server further including:
a statistical database;
said data manager module analyzing, classifying and processing said private branch exchange statistical information according to a predetermined time unit, and storing processed statistical information into said statistical database;
said reporter module determining whether said user requests transmission of said private branch exchange statistical information;
said reporter module processing the processed statistical information stored in said statistical database into an HTML file containing the processed statistical information, when it is determined that the user of the client personal computer requests said private branch exchange statistical information, and transmitting the HTML file containing the processed statistical information to the client personal computer.

10. The system as set forth in claim 4, said operation information web server further including:
a statistical database;
said data manager module analyzing, classifying and processing said private branch exchange periodic statistical information according to a predetermined time unit, and storing processed periodic statistical information into said statistical database;
said reporter module determining whether said user requests transmission of said private branch exchange periodic statistical information;
said reporter module checking whether or not said user inputs periodic statistical process conditions when the reporter module determines that the user has not requested transmission of said private branch exchange periodic statistical information;
a scheduler module for setting process conditions according to the input periodic statistical process conditions when the reporter module determines that the user has input said periodic statistical process conditions;
a statistical information process timer storing a process time interval, said statistical information process timer being set by said scheduler module according to said input periodic statistical process conditions;
said scheduler module checking said statistical information process timer to determining whether said process time interval is reached when said user does not request transmission of said private branch exchange periodic statistical information;
said scheduler module processing the private branch exchange periodic statistical information stored in said statistical database into an HTML file containing the processed periodic statistical information according to said periodic statistical process conditions, when it is determined that the process time interval is reached, and storing the HTML file containing the processed periodic statistical information in a hard disk drive; and
said reporter module transmitting the HTML file containing the processed periodic statistical information to the client personal computer.

11. A method providing private branch exchange operation information, outputted from a private branch exchange through a computer-telephony integration interface as computer-telephony integration events, to a client personal computer, the method comprising steps of:
storing the private branch exchange operation information received through the computer-telephony integration interface in a memory of an operation information web server;
receiving a request over an Internet at the operation information web server for the private branch exchange operation information from at least one said client personal computer connected to the operation information web server;
processing the private branch exchange operation information stored in said operation information web server into an HTML (Hyper Text Markup Language) file containing the requested private branch exchange operation information;
transmitting the HTML file to the client personal computer; and
displaying the received HTML file containing the private branch exchange operation information on a monitor connected to said client personal computer.

12. The method as set forth in claim 11, said storing step further comprising steps of:
extracting said private branch exchange operation information from the computer-telephony integration events received from the private branch exchange; and
storing extracted private branch exchange operation information in a shared memory.

13. The method as set forth in claim 11, the stored private branch exchange operation information comprising private branch exchange monitoring information, private branch exchange statistical information, private branch exchange periodic statistical information and private branch exchange diagnostic information.

14. The method as set forth in claim 13, further including steps of:
extracting said private branch exchange operation information from the computer-telephony integration events received from the private branch exchange;
generating processed information by analyzing, classifying and processing the extracted private branch exchange operation information;
storing the extracted private branch exchange operation information and the processed information in a shared memory; and
processing the extracted information or the processed information stored in the shared memory into the HTML file containing the requested private branch exchange operation information, when a user of the client personal computer requests said private branch exchange operation information, and transmitting the HTML file containing the processed information to the client personal computer.

15. The method as set forth in claim 14, further comprising steps of:
determining whether said user requests transmission of said private branch exchange monitoring information;
checking a monitoring information timer to determining whether a time interval for transmission of said private branch exchange monitoring information is reached when it is determined that said user does not request transmission of said private branch exchange monitoring information;
checking whether said time interval for transmission of said private branch exchange monitoring information is input by said user when it is determined that said user requests transmission of said private branch exchange monitoring information;
setting said time interval for transmission of said private branch exchange monitoring information into said monitoring information timer when it is determined that said time interval for transmission of said private branch exchange monitoring information is input; and
processing the private branch exchange monitoring information stored in the shared memory into an HTML file containing the requested private branch exchange monitoring information, after said time interval for transmission of said private branch exchange monitoring information is reached, when it is determined that said time interval for transmission of said private branch exchange monitoring information is not input or after said monitoring information timer is set with said time interval for transmission of said private branch exchange monitoring information upon determination that said time interval for transmission of said private branch exchange monitoring information is input, and transmitting the HTML file containing the private branch exchange monitoring information to the client personal computer.

16. The method as set forth in claim 14, further comprising steps of:
determining whether said user requests transmission of said private branch exchange diagnostic information;
checking a diagnostic information timer to determining whether time interval for transmission of said private branch exchange diagnostic information is reached when said user does not request transmission of said private branch exchange diagnostic information;
checking whether said time interval for transmission of said private branch exchange diagnostic information is input by said user when said user requests transmission of said private branch exchange diagnostic information;
setting said time interval for transmission of said private branch exchange diagnostic information into said diagnostic information timer when it is determined that said time interval for transmission of said private branch exchange diagnostic information is input; and
processing the private branch exchange diagnostic information stored in the shared memory into an HTML file containing the requested private branch exchange diagnostic information, after said time interval for transmission of said private branch exchange diagnostic information is reached, when it is determined that said time interval for transmission of said private branch exchange diagnostic information is not input or after said diagnostic information timer is set with said time interval for transmission of said private branch exchange diagnostic information upon determination that said time interval for transmission of said private branch exchange diagnostic information is input, and transmitting the HTML file containing the private branch exchange diagnostic information to the client personal computer.

17. The method as set forth in claim 16, said private branch exchange diagnostic information including information for system statuses and information for alarm and fault statuses.

18. The method as set forth in claim 17, further comprising steps of:
analyzing, classifying and processing said private branch exchange diagnostic information;
storing, as a result of the analyzing, classifying and processing step, information related to changes in said alarm and fault statuses in said shared memory;
storing, as a result of the analyzing, classifying and processing step, log information according to information related to changes in said alarm and fault statuses in a log database;
processing the information related to changes in said alarm and fault statuses stored in the shared memory into an HTML file containing the requested information related to changes in said alarm and fault statuses, after said time interval for transmission of said private branch exchange diagnostic information is reached, when it is determined that said time interval for transmission of said private branch exchange diagnostic information is not input or after said diagnostic information timer is set with said time interval for transmission of said private branch exchange diagnostic information upon determination that said time interval for transmission of said private branch exchange diagnostic information is input, and transmitting the HTML file containing the information related to changes in said alarm and fault statuses to the client personal computer;
determining whether said user requests log information after transmitting the HTML file containing the information related to changes in said alarm and fault statuses to the client personal computer; and
extracting the log information from said log database, when it is determined said user requests the log information, and processing the log information into an HTML file containing the requested log information and transmitting the HTML file containing the log information to the client personal computer.

19. The method as set forth in claim 14, further comprising steps of:
analyzing, classifying and processing said private branch exchange statistical information according to a predetermined time unit;
storing, as a result of the analyzing, classifying and processing step, processed statistical information into a statistical database;
determining whether said user requests transmission of said private branch exchange statistical information;
processing the processed statistical information stored in said statistical database into an HTML file containing the processed statistical information, when it is determined that the user of the client personal computer requests said private branch exchange statistical information, and transmitting the HTML file containing the processed statistical information to the client personal computer.

20. The method as set forth in claim 14, further comprising steps of:
analyzing, classifying and processing said private branch exchange periodic statistical information according to a predetermined time unit;
storing, as a result of the analyzing, classifying and processing step, processed periodic statistical information into a statistical database;
determining whether said user requests transmission of said private branch exchange periodic statistical information;
checking whether or not said user inputs periodic statistical process conditions when it is determined that the user has not requested transmission of said private branch exchange periodic statistical information;
setting process conditions according to the input periodic statistical process conditions when it is determined that the user has input said periodic statistical process conditions;
storing a process time interval in a statistical information process timer according to said input periodic statistical process conditions;
checking said statistical information process timer to determining whether said process time interval is reached when said user does not request transmission of said private branch exchange periodic statistical information;
processing the private branch exchange periodic statistical information stored in said statistical database into an HTML file containing the processed periodic statistical information according to said periodic statistical process conditions, when it is determined that the process time interval is reached, and storing the HTML file containing the processed periodic statistical information in a hard disk drive; and
transmitting the stored HTML file containing the processed periodic statistical information to the client personal computer.
